(19) United States
(12) Patent Application Publication
(10) Pub. No.: US 2019/0351484 A1
(43) Pub. Date: Nov. 21, 2019

(54) METAL PASTES FOR ADDITIVE MANUFACTURING

(71) Applicant: 3D Flexible, Inc., College Park, MD (US)

(72) Inventors: Victor E. YUN, College Park, MD (US); Yongzhang LENG, College Park, MD (US)

(21) Appl. No.: 16/016,651

(22) Filed: Jun. 24, 2018

Related U.S. Application Data
(60) Provisional application No. 62/674,017, filed on May 20, 2018.

(51) Int. Cl. B22F 1/00; B22F 3/00; B33Y 10/00; B33Y 70/00

(52) U.S. Cl. CPC B22F 1/0074; B22F 3/008; B22F 9/082; B33Y 10/00; B33Y 70/00; B22F 1/0011

(57) ABSTRACT

An additive manufacturing metal paste and a method of additive manufacturing using the metal paste is presented. The metal paste includes a first metal component of a first majority-phase structural metal, the first majority-phase structural metal comprising approximately 75 wt. % to approximately 90 wt. % first metal particles having a particle size of approximately 1 micron to approximately 100 microns. The metal paste further includes a second metal component of a second bonding metal, the second bonding metal comprising approximately 3 wt. % to approximately 10 wt. %, the second metal particles having a particle size of approximately 3 nanometers to approximately 100 nanometers. The paste further includes a binder having a weight percentage of approximately 2 wt. % to approximately 15 wt. % wherein the metal paste has a sintering temperature of less than approximately 300° C.

### CROSS-REFERENCE TO RELATED APPLICATIONS

This application claims priority to U.S. Provisional Patent Application No. 62/674,017 filed 20 May 2018, the disclosure of which is incorporated by reference herein.

### GOVERNMENT RIGHTS

The invention disclosed herein was made at least in part with funding by the U.S. Government, specifically the United States Department of Defense under contract number W56HZV-17-C-0186. Therefore, the U.S. Government has certain rights in this invention.

### FIELD OF THE INVENTION

The present invention relates to additive manufacturing and, more particularly, to additive manufacturing of metal objects using metal pastes that sinter at a temperature below 300° C.

### BACKGROUND

Employing metals in additive manufacturing may lead to large cost reductions for both prototyping and parts production, having the potential to revolutionize manufacturing. Due to the high melting temperature of metallic powders requiring associated expensive processing techniques, metallic additive manufacturing is typically limited to high-value items, such as commercial aviation parts or medical implant devices. However, there are no current additive manufacturing processes that can print large metallic structures, while still preserving surface quality.

Currently, there are two techniques primarily employed in metal additive manufacturing systems: the direct process powder bed system, and the powder-bed binder jet system. In the direct-process powder bed system, layers of metallic powder are deposited from a powder bed and fused using a high-power laser or electron beam for melting. The direct process powder-bed systems need to maintain the fabrication chambers (the build area) under inert gas to prevent metallic powder from oxidizing while being treated by the high-power laser heating the metal powder to its melting point temperature. For electron beam systems, the build area is typically maintained under a vacuum.

The powder-bed binder jet system uses a high-speed inkjet printer to print a binding polymer mix (epoxy) to define the layered structure from a CAD design file. The printed parts from a binder jet need to be sintered inside a high temperature furnace or a microwave furnace up to 1400° C.

The cost and the required real estate space of the direct process powder-bed systems limits the adoption of metal additive manufacturing technology. The slow build speed also hampers its penetration into rapid prototyping and customized production due to the high usage cost. Metal powder sintering near its melting temperature is also a significant problem which limits the potential to revolutionize the supply chains and manufacturing processes even for low volume and low-cost part production. In addition, the current metallic additive processes lack scalability due to the requirements on the build chamber.

Thus, there is a need in the art for additive manufacturing of metal objects that preserve surface finish, is low-cost, and low-temperature.

### SUMMARY OF THE INVENTION

The present invention relates to an additive manufacturing metal paste and a method of additive manufacturing using the metal paste. The metal paste includes a first metal component of a first majority-phase structural metal, the first majority-phase structural metal comprising approximately 75 wt. % to approximately 90 wt. % first metal particles having a particle size of approximately 1 micron to approximately 100 microns. The metal paste further includes a second metal component of a second bonding metal, the second bonding metal comprising approximately 3 wt. % to approximately 10 wt. %, the second metal particles having a particle size of approximately 3 nanometers to approximately 100 nanometers. The paste further includes a binder having a weight percentage of approximately 2 wt. % to approximately 15 wt. % wherein the metal paste has a sintering temperature of less than approximately 300° C.

### BRIEF DESCRIPTION OF THE DRAWINGS

FIG. 1 schematically depicts the structure of a unsintered and sintered metal paste according to an embodiment;

FIG. 2A-2D each schematically depict an apparatus including a nozzle and pressure regulator for depositing the metal paste of FIG. 1;

FIGS. 3A and 3B depict inner and outer wall deposition for later backfilling using the metal pastes of the present invention;

FIGS. 4A-4D depict fabrication of a metal dome using the metal pastes of the present invention;

FIGS. 4E-4F depict fabrication of various curved shapes by additive manufacturing;

FIGS. 5A-5D depict toolpaths for fabricating a variety of shapes by additive manufacturing with metal pastes;

FIGS. 6A-6B depict deposition of metal paste line from a nozzle;

FIGS. 7A-7C depict fabrication of a metal box using the metal paste of the present invention.

### DETAILED DESCRIPTION

In contrast to the prior art techniques, the present invention employs viscoelastic metallic pastes to print various three-dimensional objects such as metal cubes and domes with high aspect ratios. Although numerous silver and copper conducting metal pastes exist for electrical trace fabrication, metallic pastes based on other metals, e.g. steel, for structural applications are not commercially available. Using the inventive metal pastes, metallic structures with complex features (cavities and voids) can be fabricated by additive manufacturing with CAD/CAM toolpath optimization.

The inventive technique does not require high energy beam heating (laser or electron beam) or complex processing chambers/shielding gases and is easily scalable. The metallic structures of the present invention have been sintered at less than 300° C., more particularly at less that 250° C. The approach used in the present invention can also be applied to metallic pastes of a wide various of metals including ferrous metals, cobalt, nickel-based alloys, or ceramics. Because the metal pastes of the present invention can be deposited in an open environment without the use of laser or electron beams, complex features may be fabricated with internal cavities and intentional voids either for cooling or weight reduction.

The size dependence of the melting point of very small particles (the melting-point depression) has been studied since the 1960s. Molecular dynamics simulation has been performed to study the effects of particle size on melting temperatures of different metal nanoparticles. At nanoscales, metallic particles show thermo-physical properties distinct from those at microscales. The particle size in conductive nanoparticle pastes ranges from approximately 3 nanometers to less than 100 nm. Nanoparticles at the low-end size distribution may see significant melting temperature suppression. However, the particle size distribution for metallic powders used in commercial powder-bed metal additive systems is usually between 10-50 microns, according to the layer thickness. The melting temperature of these metallic particles is the same as its bulk melting temperature.

Nanoparticle silver pastes have been successfully used as die attach bonding materials in the microelectronic packaging industry to eliminate lead from electronic materials because of its hazardous effect on human health. Bonding using metal nanoparticles has the advantage of the nanoparticles fusing to become a metallic solid after low temperature fusing process (sintering); the melting temperature of the sintered metallic solid approaches its bulk melting temperature.

Introducing nanoparticles into metallic additive manufacturing processes will drastically reduce the temperature requirement for sintering fabricated metallic parts to achieve structural strength. Implementing a FDM (fused deposition modelling)-equivalent metallic paste additive manufacturing process, which uses only the amount of material needed for the metallic structure, contrasts with laying down thin layer-by-layer metallic powders across an entire bed volume, with most powder unused, as in prior art powder bed systems. Thus, additive manufacturing processes using the inventive metal pastes of the present invention significantly reduce the usage of metallic powder.

Primary Metal Component

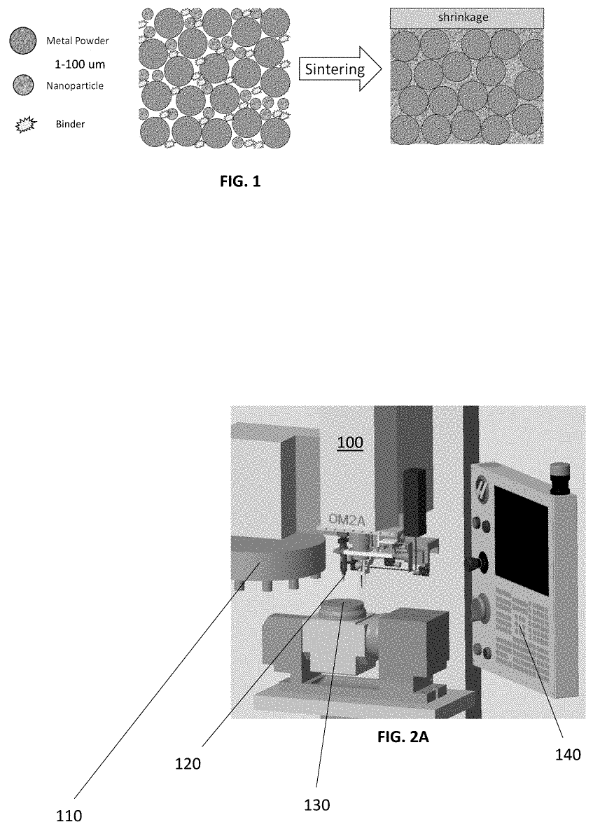

The present invention uses innovative metallic materials and processes to build metallic structures. As shown in FIG. 1, the metal pastes of the present invention include a first metal component of a first majority-phase phase structural metal comprising approximately 75 wt. % to approximately 90 wt. % of the total metal paste of first metal particles having particle sizes of approximately 1 micron to approximately 100 microns. A second metal component of a second binder-phase metal in the form of nanoparticles is included in the metal paste. The second binder-phase metal comprises approximately 3 wt. % to approximately 10 wt. % of the total metal paste weight. The second metal particles have a particle size of approximately 3 nanometers to approximately 100 nanometers. To make the paste flow and to hold the metal particles together, a binder having a weight percentage of approximately 2 wt. % to approximately 15 wt. % of the total metal paste weight is included. The binder may also be used to control the viscosity of the mixture, making the paste precision-controllable for various selected printing viscosities depending upon the object being deposited.

In one embodiment, gas atomization may be used to manufacture high quality metal powders use as the first majority-phase phase structural metal in the metal pastes of the present invention. During the gas atomization process, a molten metal is atomized with inert gas jets into fine metal droplets which cool down during their fall in an atomizing tower. Metal powders obtained from gas-atomization offer an almost perfectly spherical shape combined with a high cleanliness level. The spherical metallic powder particles have excellent flow characteristics, achieving a high operating metallic paste viscosity for freestanding structure fabrication.

The size of particles produced by gas atomization may be controlled by varying process parameters such as: inert gas pressure, melt properties, nozzle design, and gas-to-metal ratio. Various post atomization processes including “scalping” to remove the oversize particles followed by either air classification or sieving are applied to obtain the required size fraction.

Particles having sizes between 1 to 10 microns, if detached, can become an airborne health and safety risk. In the present invention, metal paste preparation process occurs inside a reducing atmosphere hood and the resulting paste will not have detachable particles. Further, the metal powders used in the present invention may have a broader size distribution than those used in prior art powder bed processes, permitting the use of lower cost metal powders, typically of the same quality as those used in metal injection molding. The diverse particle size distribution results in a high packing density and enables high powder loading. This combination reduces the shrinkage of additive manufacturing fabricated parts during sintering and minimizes the nano-metal powder costs.

Nanoparticle Second Phase

A second metal component of a second binder-phase metal in the form of nanoparticles is included in the metal paste. The second binder-phase metal comprises approximately 3 wt. % to approximately 10 wt. % of the total metal paste weight. The second metal particles have a particle size of approximately 3 nanometers to approximately 100 nanometers. The use of nanoparticles in the metal pastes of the present invention drastically decreases the sintering temperature for establishing metallic alloying bonding between the nanoparticles and the larger metal powders. Nanoscale metal particles display a drastically reduced melting temperature compared to larger particle sizes or bulk metals. The reason for the melting point depression of nanoparticles may be understood by invoking the ratio of the number of surface atoms to the total number of atoms making up the particle. In bulk, this number is negligibly small. However, for nanoscale particles, the number of surface atoms is comparable to the total number of atoms. The bonding of atoms at the surface is much weaker, so the surface layer melts more easily than the bulk. The melting point of solids decreases initially slowly, then more rapidly as particle sizes decrease.

Binder

To make the paste flow and to hold the first and second metal particles together, a binder having a weight percentage of approximately 2 wt. % to approximately 15 wt. % of the total metal paste weight is included. The binder may also be used to control the viscosity of the mixture, making the paste precision-controllable for various selected printing viscosities depending upon the object being deposited.

Typical binders used may be organic solvents or polymeric binders depending upon the desired viscosity and other desired rheological properties. In one embodiment, a glycol ether is used as the binder such as diethylene glycol mono-n-butyl ether (C₈H₁₈CO₃, DEGBE).

For deposition, the metal pastes of the present invention are typically loaded into a syringe barrel and then dispensed out of a nozzle. Because of this dispensing technique, the binder may be selected to give the overall metal paste the following properties: shear-thinning behavior to facilitate flow through fine nozzles without clogging, and viscoelastic behavior to enable printing of self-supporting structures. By using metallic powders of the first metal with particle sizes in the range of 1-100 microns, a non-Newtonian fluid paste may be formed with sufficient shear thinning and viscoelastic properties to be extruded through a nozzle to build a structure with a high aspect ratio. The composition and rheology of the metallic paste is adjusted to ensure reliable flow through a fine dispensing nozzle with an inner diameter that may be as small as 200 microns. The metal pastes of the present invention also promote bonding and adhesion between printed layers, to support the structural integrity during the drying and sintering processes.

Sintering

Following deposition, the printed metal structures are heated to fuse the particles as depicted in FIG. 1. Depending upon the selected second metal nanoparticles, the objects may be heated to a temperature of less than 300 C, more particularly, less than 250 C or less than 200 C. The sintering temperature depends on the nanoparticle size. The smaller the nanoparticle, the lower the sintering temperature due to melting temperature suppression related to nanoparticle size and the ratio of volume particles to surface particles. Therefore, the selected temperature will relate to the size of the second metal nanoparticles.

Metals

A large variety of metals may be deposited using the metal pastes of the present invention. In one aspect, the first metal may be aluminium, aluminum alloys, copper, copper alloys, cobalt, iron, iron alloys, steel, titanium, titanium alloys, or iron-nickel alloys; however, other metals may also be used. The nanoparticle second metal may also be selected from the above list of metals and may be the same as the first metal or different from the first metal. In addition to the above metals, the second metal may be silver or a silver alloy.

In one embodiment, maraging steel powders are used as the first metal in the metal pastes of the present invention. Maraging steel is class of low-carbon ultra-high-strength steels that have precipitates including alloying metals such as nickel, typically in a range from 15 to 25 weight percent, cobalt, molybdenum, and titanium. Maraging steel and good strength and toughness while also being malleable and machinable. In one embodiment, when maraging steel is selected for the first metal, silver, silver alloy, copper, or copper alloy is selected for the nanoparticle second metal.

Further Additives

Additional particles may be added to the metal pastes of the present invention to create custom mechanical properties in the deposited metal part. For example, ceramic particles such as silicon carbide and aluminum oxide may be added to create ceramic-in-metal matrices to improve the strength of the deposited metals. For this application, the ceramic particles may be added at a percentage of approximately 5-30 wt. %. Custom alloys may be created by selecting more than one type of first metal particle (e.g., iron and nickel first metal particles). Likewise, plural metals may be selected for the nanoparticle second-phase metal.

Additive Manufacturing with Metal Pastes of the Present Invention

Additive manufacturing may be performed using a machine tool having syringe-based deposition heads. For example, commercial-based solder deposition machine tools may be used to deposit the metallic pastes of the present invention. Optionally, when manufacturing precision parts, the metallic pastes of the present invention may be deposited using an additive-manufacturing platform implemented, on a multiple axis tool, such as on a 5-axis machine tool, that includes syringe-based deposition heads.

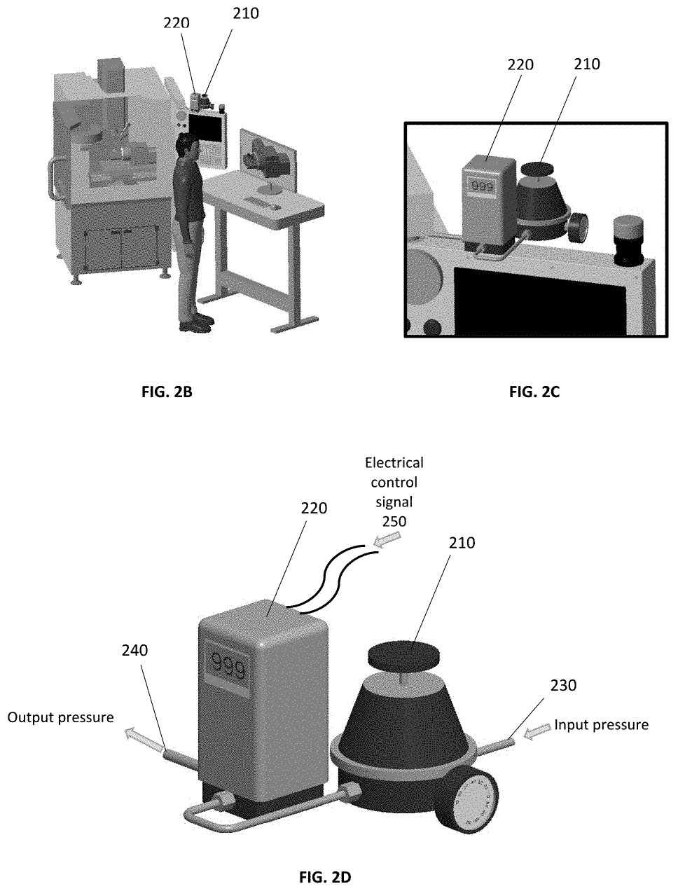

An exemplary deposition apparatus is depicted in FIG. 2A. FIG. 2A depicts a modified Haas compact mill CM-1 100 with CAM control provided by the combination of PTC Creo CAD/CAM. This software has been used to design and generate toolpaths for the additive manufacturing processes; further control is provided by an interactive front control panel 140. As shown in FIG. 2A, the apparatus integrates fused deposition modelling, inkjet printing, aerosol printing, laser ablation, laser curing, UV curing, pneumatic pressure-based printing heads 120, and conventional machine tools (milling tools, drills, cutters, etc.) in a single 5-axis platform controlled by CAD/CAM techniques. These multiple functions in a single system allow maintaining a static reference coordination in additive manufacturing, resulting in better alignment while forming multilayer structures with multiple materials. A tool changer 110 is positioned next to printing head 120 and contains the various tools which may be positioned at the location of head 120 when used in a fabrication process. Stage 130 supports a workpiece (not shown).

FIGS. 2B, 2C, and 2D depict a modification of the system of FIG. 2A in which an additional pressure regulation system 210, 220 is depicted. Pressure regulation system 210, 220 may be used to custom regulate a dispensing nozzle pressure in coordination with movement of a workpiece on state 130. This regulation of the dispensing nozzle will be discussed in further detail below.

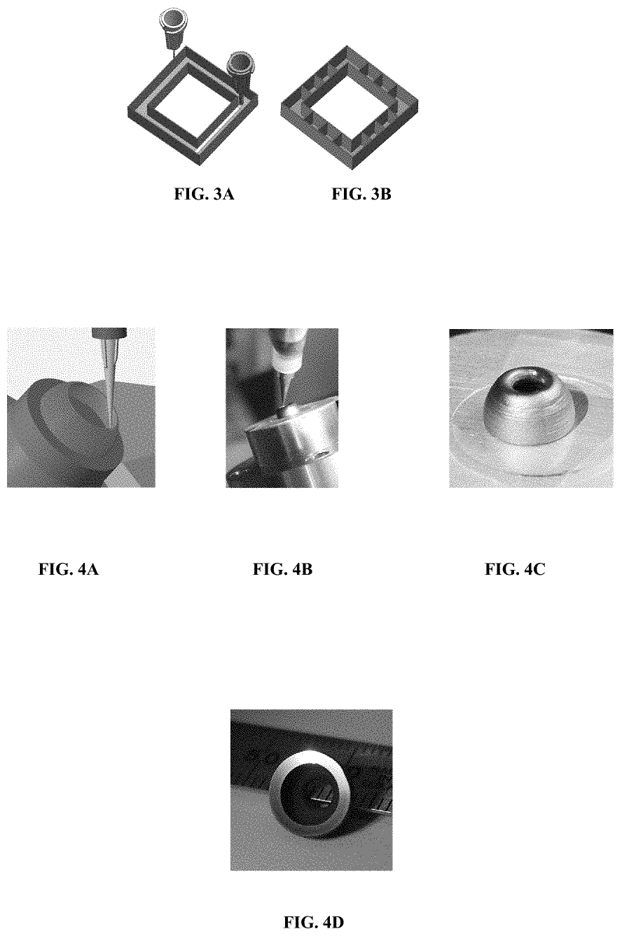

As discussed, the 5-axis system of FIG. 2A may be equipped with multiple heads; plural heads may be used to dispense the same metal paste but with different-sized nozzles to accommodate the requirements for different-sized parts and different-sized features on the same part. Depending upon the selected paste particle sizes and tailored paste viscosity, large inner diameter dispensing nozzles may be used to accelerate the metal paste dispensing and metallic structure build speed while still preserving surface quality. If the fabricated part has high surface finishing requirements, multiple dispensing heads with small nozzles may be used to build the inner and outer surfaces of the metallic structure before filling the space between the surfaces with metallic paste having a larger nozzle to complete the product. Such a technique is depicted in FIGS. 3A-3B. In FIG. 3A, a small nozzle builds the inner and outer walls of the hollow square part. As seen in FIG. 3B, ribs may be used to join the inner and outer surfaces. After creating the structure of FIG. 3B, a larger-sized nozzle may be used to rapidly fill the spaces between the ribs.

In addition to being rapid, there is another advantage to using a larger-sized nozzle. For a metal powder paste with a fixed particle size range, there is less chance for a large inner diameter nozzle to clog than for a small inner diameter nozzle. Empirically, smooth paste dispensing (no clogging) requires a particle size to be approximately 20 times smaller than the nozzle size. Thus, for an average particle size on the order of 10 microns, a nozzle size of 200 microns will typically remain unclogged. Such a size is typically sufficient as the small nozzle. Thus, for larger “fill” nozzles, the same particle size metal paste may be used with no clogging or a larger diameter metal paste may be used with the larger nozzle.

For the metal pastes with selected viscoelastic properties, the viscosity of the paste decreases as the syringe pressure increases or as the paste dispensing speed increases. The faster ejection speed metal paste leaving the nozzle leads to a lower viscosity of the metal paste inside the nozzle. Optimizing additive manufacturing processes to take advantage of this viscoelastic property leads to greater structure build speed while preserving surface quality.

The building procedure of FIGS. 3A-3B provides another capability: building finer cavities or intentional voids. Therefore, to reduce the weight of a part, some of the cavities created by the reinforcing ribs in FIG. 3B may be left unfilled.

Complex Build Geometries

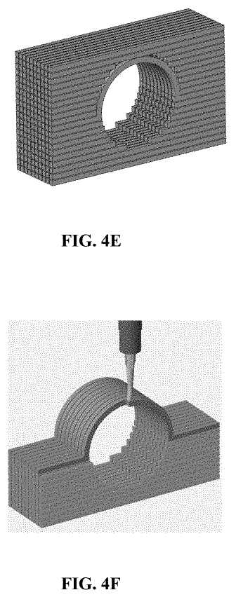

With the inventive metal pastes various three-dimensional metallic structures may be fabricated. Exemplary shapes include cubes and domes. FIG. 4A depicts a toolpath for printing a dome. The dispensing nozzle tip is positioned to be tangent to the growing hemispherical surface. The combination of the toolpath generation preference and the small radius dome permits dome build angles up to 70°. FIG. 4B depicts a self-supported 9 mm radius metallic dome being fabricated using a metal paste of maraging steel powder and copper nanoparticles. FIG. 4C depicts an as-deposited metallic dome with an opening of 200 while FIG. 4D shows metallic finishing after sintering the as-deposited structure using a hot plate at 200° C. for 30 minutes. FIGS. 4E and 4F illustrate the toolpaths and building steps, generated by Creo CAD/CAM Manufacture, to build a metallic structure with a circular opening.

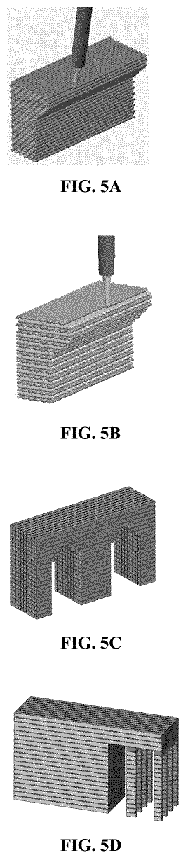

FIGS. FIG. 5A-5D illustrates toolpaths generated by Creo CAD/CAM Manufacture for building metallic structures with different size overhangs. FIG. 5A shows an angled layer-by-layer deposition process. FIG. 5B shows an angled layer-by-layer building process with alternative layers using orthogonal toolpaths. The toolpath design connects the already dispensed layers and reinforces structure's mechanical integrity. FIG. 5C illustrates the toolpaths for building a structure with double arches. For small metallic structure with overhangs, overhangs can be printed by rotating the already-printed structure 90 degrees to complete the overhangs. However, turning a large already-built metallic structure sideways before it is completely dried may not be an option since the structure is self-supporting, especially with high aspect ratio (wall). FIG. 5D illustrates the toolpaths for a structure with an extended overhang, plus sacrificial scaffolds. Using Creo CAD/CAM, complex structures can be designed and proper toolpaths will be generated to accommodate the metal paste additive manufacturing processes.

Uniform Dispensing

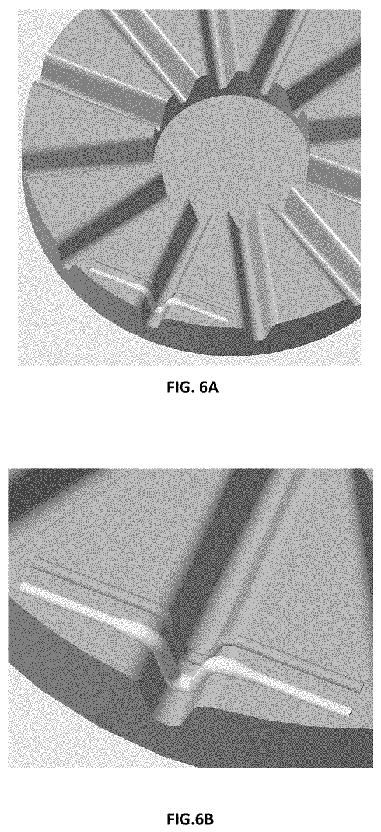

For additive manufacturing, the rate of material dispensed through pneumatic nozzles is dependent upon the material viscosity (typically temperature dependent), the inner diameter (ID) of the nozzle/needle and the applied pressure. For a 3D additive manufacturing system, the speed of the stage movement varies throughout the dispensing process, particularly for a 5-axis system with A and B axes. If the nozzle-dispensing parameters remain constant during the fabrication process, there will be excess material dispensed when the stage slows down. This excess dispensed material affects both the mechanical and the electrical properties of the product being formed, in addition to affecting the aesthetic appearance. As illustrated in FIG. 6A, the dispensed trace (white) has a significant dimension enlargement at the curved portion of the substrate when the linear dispensing speed of the CNC mill slows down with full 5-axis motion. FIG. 6B shows the close-up of the substrate curvatures and the dispensed traces. The trace (white) without automatic pressure adjustment has a sausage-shaped sections and is clearly not uniform in dimension.

Previous efforts have focused on accommodating the pressure differential between the applied pressure and the true pressure at the exit of a material dispensing device, such as a syringe barrel. These efforts were aimed at achieving a uniform dispensing rate of the material versus time. However, this uniform dispensing rate is contrary to the requirements of 3D additive manufacturing. Because the stage speed varies significantly during the manufacturing process, the constant dispensing rate leads to excess material dispensed at sections where the speed of stage movement decreases due to change in direction and/or multiple axis movement. Therefore, the present invention controls the dispensing rate of material so that uniformly deposited conductive/dielectric traces or layers can be achieved, as the gray dispensed trace illustrated in FIG. 6B.

One way to implement the variable rate dispensing of material is adjusting the pressure applied to the barrel of the pneumatic nozzle proportional to the stage speed. As seen in FIG. 2D, an electrical control signal 250 produces a proportional voltage to control a dynamic pressure regulator 220. An exemplary commercially-available dynamic pressure regulator used in the present invention is the QPV1 from Equilibar which is an electronic high-resolution pressure control valve. The pressure regulator may include plural internal solenoid valves and a pressure transducer. The solenoid valves may act as inlet and outlets to provide a regulated outlet pressure in proportion to the input electrical control signal 250. It is available in a wide range of calibrated pressure ranges covering vacuum through 150 psig (10 Bar). The QPV1 is available in either 0-10 VDC or 4-20 mA analog signal types, both of which may be used in the process of the present invention. An input pressure enters though port 230 of constant-output pressure regulator 210, is precisely regulated by dynamic pressure regulator 220 and is output to outlet 240 for actuating pneumatic nozzle 120 of FIG. 2A.

A second way to implement the variable rate dispensing of material is using a vision system to monitor the dimension of the dispensed traces, both the width and the height. The information from the vision system is fed to the electronic feedback circuit to generate a proportional voltage. The voltage controls the precision pressure valve, such as Equilibar's QPV1. The vision system includes a telecentric lens, which provides the same magnification at all distances, within a certain distance range, to monitor the dimensions of the dispensed traces with a calibrated CCD camera. Thus, the active pneumatic pressure tuning of the present invention provides uniform width and height of the deposited traces.

### Example 1: Maraging Steel Metal Paste

A metal powder of maraging steel powder from a gas atomizer, having 15 to 25 weight percent of nickel, with cobalt, molybdenum, titanium and iron as the balance is selected as the first metal powder. The particle size is on the order of 10 microns. The nanoparticles are selected to be silver nanoparticles having a size of approximately 20 nanometers. The silver nanoparticles are used in the form of a silver nanoparticle ink that includes diethylene glycol mono-n-butyl ether (C₈H₁₈O₃, DEGBE), a high boiling point solvent, that acts as a binder for the metal particles of the ink. The metal paste was prepared by gradually adding the maraging steel powder into the silver nanoparticle paste while it is being stirred/mixed with a stainless steel spatula inside a 10 mL glass beaker. Although the shape of the gas-atomized steel particles is relatively spherical, it still requires considerable care to blend the maraging metal powder with the viscous silver nanoparticle paste. After the silver nanoparticle paste is well-blended well with the initial quantity of maraging steel powder, more maraging steel powder is gradually added. Extra care is needed to ensure the uniformity of the metallic paste without any unmixed maraging steel powder, which can clog the small dispensing nozzle of 200 microns inner diameter. With an extended period of stirring, a metal paste is formed with approximately 85% maraging steel powder, 5% silver nanoparticle paste (with Ag concentration 91 wt. %) and 10% of binder. The maraging steel paste was used to build several self-supporting structures as depicted in the FIGS.

Although the additive manufacturing metal paste was prepared by mixing maraging steel power with pre-formed silver paste, it is understood that dry powders of both steel and silver may be mixed together followed by addition of various solvents. It is also understood that the viscosity of the paste may be controlled through control of the metal powder loading and solvent loading and that different viscosities may be selected depending upon the shape to be deposited. For example, shapes with a high aspect ratio may require pastes with a greater viscosity while for flatter designs a lower viscosity paste may be selected.

### Example 2

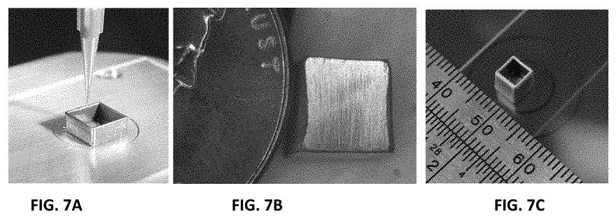

The maraging steel paste of Example 1 is dispensed using a 200-micron inner diameter tapered plastic nozzle. Different sizes of self-supporting boxes were built layer by layer with a high aspect ratio. FIG. 7A shows a 10 mm×10 mm×5 mm metallic box being fabricated. The wall thickness of this box is 0.65 mm. FIG. 7B shows the side wall finishing after sintering by placing this box over a hot plate at 200° C. for 30 minutes and then sanding.

FIG. 7C shows a picture of a 5 mm×5 mm×5 mm metallic cube fabricated using the inventive metal paste of Example 1. This free-standing metallic structure was air dried, a process that can be accelerated by circulating warm, dry air. After completely drying, this metallic cube can be sintered to its full mechanical strength by placing it on a hot plate at a temperature less than 200° C. for less than 60 minutes. This temperature is much lower than the bulk melting temperatures of the metallic paste ingredients.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated.

1. An additive manufacturing metal paste, comprising:
a first metal component of a first majority-phase structural metal, the first majority-phase structural metal comprising approximately 75 wt. % to approximately 90 wt. % first metal particles having a particle size of approximately 1 micron to approximately 100 microns;
a second metal component of a second binder-phase metal, the second binder-phase metal comprising approximately 3 wt. % to approximately 10 wt. % second metal particles having a particle size of approximately 3 nanometers to approximately 100 nanometers;
a binder having a weight percentage of approximately 2 wt. % to approximately 15 wt. % wherein the metal paste has a sintering temperature of less than approximately 300° C.

2. The additive manufacturing metal paste according to claim 1, wherein the first metal component is selected from aluminium, aluminum alloys, copper, copper alloys, cobalt, iron alloys, steel, titanium, titanium alloys, or iron-nickel alloys.

3. The additive manufacturing metal paste according to claim 1, wherein the second metal includes aluminium, copper, silver, copper alloys, silver alloys, cobalt, iron alloys, steel, titanium, titanium alloys, or iron-nickel alloys.

4. The additive manufacturing metal paste according to claim 2, wherein the second metal includes copper or silver.

5. The additive manufacturing metal paste according to claim 1, wherein the first metal component comprises approximately 80 wt. % to approximately 85 wt. % of the paste.

6. The additive manufacturing metal paste according to claim 1, wherein the second metal component comprises approximately 4 wt. % to approximately 8 wt. % of the paste.

7. The additive manufacturing metal paste according to claim 1, further comprising ceramic particles in an amount from approximately 1 wt. % to approximately 5 wt. %.

8. The additive manufacturing metal paste according to claim 1, wherein the ceramic particles include silicon dioxide, aluminium oxide or silicon carbide.

9. The additive manufacturing metal paste according to claim 1 wherein the first metal is maraging steel.

10. A method of additive manufacturing comprising ejecting the metal paste of claim 1 from a nozzle and depositing it on a substrate.

11. The method of additive manufacturing of claim 10 further comprising sintering an object formed from deposited metal paste at a temperature below 300° C.

12. The method of additive manufacturing of claim 10 further comprising sintering an object formed from deposited metal paste at a temperature below 200° C.

13. The method of claim 10 wherein the metal paste is ejected at an ejection pressure proportional to a speed of deposition stage movement such that a uniform amount of metal paste is deposited.

14. The method of claim 13 wherein a pressure applied to the nozzle is proportional to the deposition stage speed.

15. The method of claim 14 wherein an electric circuit produces a proportional voltage to control a pressure regulator to apply the pressure to the nozzle.
